(19) United States
(12) Patent Application Publication
(10) Pub. No.: US 2015/0317075 A1
(43) Pub. Date: Nov. 5, 2015

(54) METHOD AND DEVICE FOR PROVIDING VIRTUAL INPUT KEYBOARD

(71) Applicant: Peiluo Sun, Beijing (CN)

(72) Inventor: Peiluo Sun, Beijing (CN)

(21) Appl. No.: 14/404,693

(22) PCT Filed: Jul. 30, 2012
(86) PCT No.: PCT/CN2012/079374

§ 371 Date: Jul. 24, 2015

(30) Foreign Application Priority Data
May 31, 2012 (CN) 201210176453.0

(51) Int. Cl. G06F 3/0488; G06F 3/0484; G06F 17/30

(52) U.S. Cl. CPC G06F 3/04886; G06F 17/30424; G06F 3/04842

(57) ABSTRACT

A computer-implemented method includes providing a virtual input-keyboard by obtaining keyboard-description information for a virtual input-keyboard that is to be provided to a user, based at least in part on the keyboard-description information, obtaining one or more keyboard objects corresponding to the virtual input-keyboard and object-resource information corresponding to each keyboard object, generating the virtual input-keyboard based at least in part on the one or more keyboard objects and the object-resource information corresponding to each keyboard object; and providing the virtual input-keyboard to the user. The one or more keyboard objects have an input hot-zone for receiving user input-operations that trigger at least one corresponding input event

### CROSS REFERENCE TO RELATED APPLICATIONS

This application is the national stage under 35 USC 371 of PCT/CN2012/079374, filed Jul. 30, 2012, which claims the benefit of the May 31, 2012 priority date of Chinese Patent Application 201210176453.0, filed on May 31, 2012, entitled “Method and Apparatus for Providing a Virtual input-keyboard,” the contents of which are incorporated herein by reference in their entirety.

### FIELD OF DISCLOSURE

The present disclosure relates to the field of computer technology, and more specifically, to providing an input device for a computer.

### BACKGROUND

As a result of the constantly increasing number of computer hardware configurations and the increasingly feature-laden software available, traditional Internet applications, mobile Internet applications and various other applications have developed rapidly. When using these applications, a user usually needs to use an input tool. Examples of such input tools include a keyboard, a mouse, and a virtual input-keyboard.

A virtual input-keyboard is a software-created keyboard that may be used like a real keyboard. The virtual input-keyboard is useful for those who, as a result of their health, cannot use a conventional keyboard. A virtual input-keyboard is also useful for those who use a device that has limited input capabilities. Examples of such devices include various kinds of mobile terminals and portable terminals.

A virtual input-keyboard can be implemented on different system platforms, e.g., Windows XP, Linux, Unix, iPhone OS, Android, Symbian OS, Pal OS, Windows Mobile, etc. For example, the small screen keyboard program of Windows XP is just a virtual input-keyboard that can be used like a real keyboard. In a digital product adopting a touch screen or a touch screen-like design, a user can use a virtual input-keyboard to input text and the like.

However, existing virtual input-keyboards are substantially set in their features. Some variation is possible. For example, a user may be able to replace the background image of the virtual input-keyboard. The Sogou input method allows a user to change a skin. But the user cannot adjust other features. For example, the user cannot adjust the size of a virtual key or its position within the virtual input-keyboard. As a result, existing virtual input-keyboard technology limits the user's input efficiency and adversely affects the user's experience.

### SUMMARY OF THE INVENTION

An objective of the present invention is to provide a method and apparatus for providing a virtual input-keyboard.

In one aspect, the invention features a computer-implemented method for communicating with a computer. Such a method includes providing a virtual input-keyboard. Providing a virtual input-keyboard includes obtaining keyboard-description information for a virtual input-keyboard that is to be provided to a user, based at least in part on the keyboard-description information, obtaining one or more keyboard objects corresponding to the virtual input-keyboard and object-resource information corresponding to each keyboard object, generating the virtual input-keyboard based at least in part on the one or more keyboard objects and the object-resource information corresponding to each keyboard object; and providing the virtual input-keyboard to the user. At least one of the keyboard objects includes an input hot-zone for receiving user-input operations that trigger at least one corresponding input event.

In some practices, generating the virtual input-keyboard includes performing adaptation processing to the object-resource information to obtain the adapted object-resource information based on predetermined object-adaptation-reference information, and generating the virtual input-keyboard based at least in part on the one or more keyboard objects and the adapted object-resource information. Among these practices are those in which the predetermined object-adaptation-reference information is either a screen attribute of the user's equipment, or object-occupancy information of a keyboard object corresponding to the object-resource information.

Other practices include obtaining a user's input operation in the input hot-zone, performing a keyboard input operation corresponding to the input operation, and providing, to the user, a result of performing the keyboard input operation. Some of these practices also include providing, to the user, input-prompt information corresponding to the input hot-zone based at least in part on the input operation, with the input-prompt information being either sound-effect information corresponding to the input hot-zone, or display information corresponding to the input hot-zone.

Still other practices include obtaining a user's keyboard-adjustment operation on the virtual input-keyboard, based at least in part on the keyboard-adjustment operation, updating one or more keyboard objects of the virtual input-keyboard and object-resource information corresponding to each keyboard object, based at least in part on the updated one or more keyboard objects and object-resource information corresponding to each keyboard object, generating the virtual input-keyboard, and providing the virtual input-keyboard to the user. Among these practices are those in which the user's keyboard-adjustment operation is either that of adjusting location information of at least one of the one or more keyboard objects, adjusting shape information of at least one of the one or more keyboard objects, adjusting the input event(s) corresponding to the input hot-zone, or adjusting object-resource information corresponding to at least one of the one or more keyboard objects.

In some practices, obtaining one or more keyboard objects includes obtaining the one or more keyboard objects based at least in part on the keyboard-description information, and obtaining the object-resource information corresponding to the keyboard object based at least in part on the keyboard object. At least one of the one or more keyboard objects includes an input hot-zone for receiving a user-input operation to trigger at least one corresponding input event.

Among these practices are those in which obtaining the object-resource information corresponding to the keyboard object based at least in part on the keyboard object includes obtaining object-resource-combination information, wherein the object-resource-combination information is generated by combining candidate object-resource information for generating the virtual input-keyboard, and extracting the object-resource information corresponding to the keyboard object from the object-resource-combination information based at least in part on the keyboard object. Also among these practices are those in which obtaining the object-resource information corresponding to the keyboard object based at least in part on the keyboard object includes performing match query in a keyboard-object-resource repository, based at least in part on the keyboard object, to obtain the object-resource information corresponding to the keyboard object.

In another aspect, the invention features an apparatus for providing a virtual input-keyboard. Such an apparatus includes a first obtaining-module, a second obtaining-module, a generating module, and a providing module. The first obtaining-module is configured to obtain keyboard-description information of a virtual input-keyboard that is to be provided to a user. The second obtaining-module is configured to, based at least in part on the keyboard-description information, obtain one or more keyboard objects corresponding to the virtual input-keyboard and object-resource information corresponding to each keyboard object. At least one of the one or more keyboard objects includes an input hot-zone for receiving user-input operations to trigger at least one corresponding input event. The generating module is configured to generate the virtual input-keyboard based at least in part on the one or more keyboard objects and object-resource information corresponding to each keyboard object. The providing module is configured to provide the virtual input-keyboard to the user.

In some embodiments, the generating module includes an adaptation unit and a generating unit. The adaptation unit is configured, based at least in part on the predetermined object-adaptation-reference information, to perform adaptation processing to the object-resource information to obtain the adapted object-resource information. The generating unit is configured to generate the virtual input-keyboard based at least in part on the one or more keyboard objects and the adapted object-resource information. Among these embodiments are those in which the predetermined object-adaptation-reference information is a screen attribute of the user's user equipment, or object-occupancy information of a keyboard object corresponding to the object-resource information.

Other embodiments include a third obtaining-module, a performing module, and a displaying module. In these embodiments, the third obtaining-module is configured to obtain the user's input operation on the input hot-zone, the performing module is configured to perform a keyboard input operation corresponding to the input hot-zone based at least in part on the input operation, and the displaying module is configured to provide, to the user, a result of performing the keyboard input operation. Among these embodiments are those in which the apparatus is configured to, based at least in part on the input operation, provide input-prompt information corresponding to the input hot-zone to the user. Examples of input-prompt information include sound-effect information corresponding to the input hot-zone, and display information corresponding to the input hot-zone.

Other embodiments also include a fourth obtaining-module and an updating module. In these embodiments, the fourth obtaining-module is configured to obtain the user's keyboard-adjustment operation on the virtual input-keyboard, the updating module is configured to, based at least in part on the keyboard-adjustment operation, update one or more keyboard objects of the virtual input-keyboard and object-resource information corresponding to each keyboard object, and the apparatus performs operations performed by the generating module and the providing module based on the updated one or more keyboard objects and object-resource information corresponding to each keyboard object. Among these embodiments are those in which the keyboard-adjustment operation is either that of adjusting location information of at least one of the one or more keyboard objects, that of adjusting shape information of at least one of the one or more keyboard objects, that of adjusting the input event(s) corresponding to the input hot-zone, or that of adjusting object-resource information corresponding to at least one of the one or more keyboard objects.

In additional embodiments, the second obtaining-module includes a keyboard-object-obtaining unit and an object-resource-information obtaining unit. In these embodiments, the keyboard-object-obtaining unit is configured to obtain the one or more keyboard objects based on the keyboard-description information. At least one of the one or more keyboard objects includes an input hot-zone for receiving user-input operation to trigger corresponding input event(s). The object-resource information obtaining unit is configured to obtain the object-resource information corresponding to the keyboard object based on the keyboard object. Among these embodiments are those in which the object-resource-information obtaining unit is further configured to obtain object-resource-combination information, wherein the object-resource-combination information is generated by combining candidate object-resource information for generating the virtual input-keyboard, and to extract the object-resource information corresponding to the keyboard object from the object-resource-combination information based on the keyboard object. Also among these embodiments are those in which the object-resource-information obtaining unit is further configured to perform match query in a keyboard-object-resource repository based on the keyboard object, and to obtain the object-resource information corresponding to the keyboard object.

As used herein, the term “based on” includes “based at least in part on.”

Other features, objectives and advantages of the present invention will become more apparent through reading the detailed description of the non-limiting embodiments with reference to the accompanying drawings, in which:

### BRIEF DESCRIPTION OF THE DRAWINGS

FIG. 1 shows a schematic diagram of an apparatus for providing a virtual input-keyboard;

FIG. 2 shows a schematic diagram of an apparatus for providing a virtual input-keyboard;

FIG. 3 shows a flow diagram of a computer-implemented method for providing a virtual input-keyboard; and

FIG. 4 shows a flow diagram of a computer-implemented method for providing a virtual input-keyboard.

In the accompanying drawings, the same or similar reference numerals represent the same or similar components.

### DETAILED DESCRIPTION

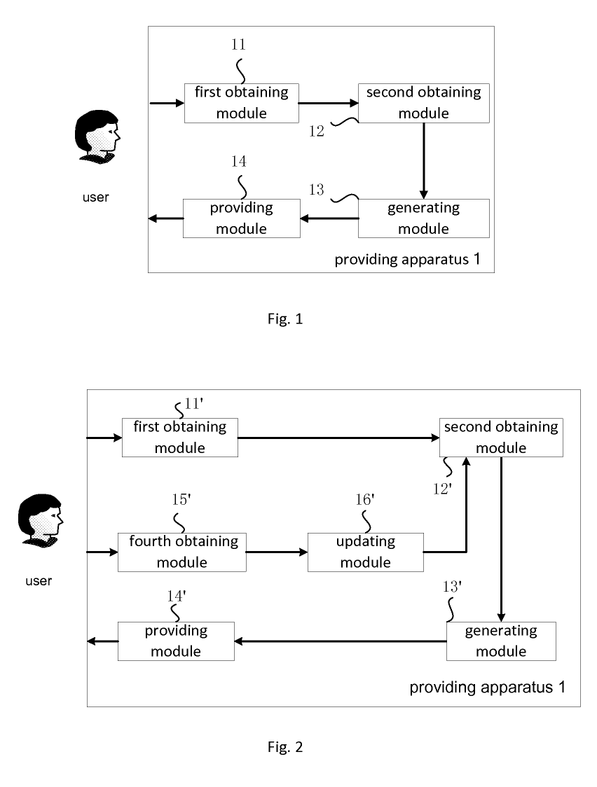

FIG. 1 shows a providing apparatus 1 for providing a virtual input-keyboard. The providing apparatus 1 comprises a server and a terminal. The server includes, but is not limited to, a single host machine, a small machine, a large machine, a plurality of host clusters, a network host machine, a single network server, a plurality of network server clusters, or a cloud composed of a plurality of servers.

The cloud is composed of a great number of computers or network servers based on cloud computing. Cloud computing is a kind of distributed computation that results in a super virtual-computer composed of a group of loosely-coupled computer clusters.

The terminal can be any terminal that can perform human-machine interaction with the user through a virtual input-keyboard. This includes, for example, various kinds of computer, smart phones, a PDA, a tablet computer, an IPTV terminal, a set top box, and a game machine.

As shown in FIG. 1, the providing apparatus 1 comprises a first obtaining-module 11, a second obtaining-module 12, a generating module 13, and a providing module 14.

Specifically, the first obtaining-module 11 obtains keyboard-description information about a virtual input-keyboard that is to be provided to a user. Obtaining the keyboard-description information includes, but is not limited to, obtaining relevant resource-information, such as information about the length and width of the display screen for displaying a virtual input-keyboard, information about the various keys on the virtual input-keyboard, and path information for storing skins. The first obtaining-module 11 also obtains virtual input-keyboard-layout information, such as information about the length and width information of the virtual input-keyboard, information about the location of the virtual input-keyboard, and information about the numbers, kinds, and location of keys of the virtual input-keyboard.

The manner of obtaining the keyboard-description information includes, but is not limited to, obtaining the keyboard-description information locally, and obtaining it from the Internet.

Obtaining keyboard-description information locally includes obtaining it through an application program interface (API), by invoking a function, or by relying on a local keyboard-description-information repository that is used to store keyboard-description information about the virtual input-keyboard.

Obtaining keyboard information from the Internet includes obtaining keyboard-description information about the virtual input-keyboard through an application program interface (API), a remote process call protocol (RPC), or a network keyboard-description-information repository, or using an agreed-upon communication protocol such as HTTP or HTTPS. The network keyboard-description-information repository is used to store keyboard-description information associated with the virtual input-keyboard.

In one example, the first obtaining-module 11 obtains keyboard-description information about the virtual input-keyboard to be provided to the user locally. When the virtual input-keyboard is actuated, the first obtaining-module 11 locally obtains keyboard-description information about the virtual input-keyboard to be provided to the user by querying a local keyboard-description-information repository. The repository contains information such as the size of the virtual input-keyboard, for example the fact that the size is 90×120, and/or the location of the keyboard, for example the fact that it is at the bottom of the display screen, and path information for storing resources corresponding to respective keys on the virtual input-keyboard.

Based on the keyboard-description information, the second obtaining-module 12 obtains one or more keyboard objects corresponding to the virtual input-keyboard, and object-resource information corresponding to each keyboard object. At least one of the one or more keyboard objects comprises an input hot-zone for receiving user-input operations to trigger corresponding input event(s).

The keyboard object comprises, for example, the type, size, skin, display area, input hot-zone of the keys on the virtual input-keyboard, e.g., whether the key is rectangular, whether the size is 25×20 pixels, whether the skin is red, whether the display area is at the bottom of the display screen, and whether the input hot-zone triggers a “water dripping sound,” etc. The input hot-zone triggers a corresponding input operation in response to receiving the user-input operation. The corresponding input operation includes display information and sound-effect information. For example, when the user clicks on the input hot-zone corresponding to the “.com” key, a sound effect, such as the sound of water dripping sound-effect, will be emitted on the virtual input-keyboard. In this case, the object-resource information comprises a picture file, a sound effect file, or a similar data structure that corresponds to each keyboard object.

The manner of obtaining one or more keyboard objects corresponding to the virtual input-keyboard and object-resource information corresponding to each keyboard object includes, but is not limited to, obtaining such information locally or obtaining such information from the Internet.

Obtaining such information locally includes, for example, locally obtaining keyboard-description information about a virtual input-keyboard to be provided to the user through an application program interface (API), invoking a function, or obtaining such information from a local keyboard-object-resource repository that is used for storing the keyboard object and its corresponding object-resource information.

Obtaining such information from the Internet includes, for example, obtaining keyboard-description information about the virtual input-keyboard to be provided to the user from the Internet through an application program interface (API), a remote process call protocol (RPC), a network keyboard-object-resource repository, or using an agreed communication manner such as HTTP or HTTPS. The local keyboard-object-resource repository is used for storing the keyboard object and its corresponding object-resource information.

As an example, the second obtaining-module 12 obtains, from the network, one or more keyboard objects corresponding to the virtual input-keyboard and their corresponding object-resource information. When the virtual input-keyboard is actuated, the first obtaining-module 11 obtains, from the network, keyboard-description information about the virtual input-keyboard to be provided to the user. It does so by using an agreed upon communication protocol, such as HTTP or HTTPS, or by querying a network keyboard-object-resource repository via an application program interface (API). Such information includes, for example, the fact that the size of the virtual input-keyboard is 90×120, the fact that the location of the keyboard is at the bottom of the display screen, and the path information for storing resources corresponding to respective keys on the virtual input-keyboard in the network keyboard-object-resource repository. Examples of objects obtained include an “mp3” file of a sound effect that is to be triggered by the input hot-zone. Such a sound effect might include, for example, the sound of water dripping.

The generating module 13 generates the virtual input-keyboard based on the one or more keyboard objects that have been obtained and object-resource information corresponding to each keyboard object.

In one example, the virtual input-keyboard is generated based on the one or more keyboard objects and the object-resource information corresponding to each keyboard object that has been obtained from the network. The first obtaining-module 11 obtains, from the network, keyboard-description information about the virtual input-keyboard to be provided to the user using an agreed communication protocol such as HTTP or HTTPS. It does so by querying a network keyboard-object-resource repository via an application program interface (API). Such information might indicate, for example that the size of the virtual input-keyboard is 90×120, that its location is at the bottom of the display screen, and that the path information for storing resources corresponding to respective keys on the virtual input-keyboard is the network keyboard-object-resource repository.

The second obtaining-module 12 obtains, from the network, one or more keyboard objects corresponding to the virtual input-keyboard and their corresponding object-resource information based on the obtained keyboard-description information, in an agreed communication protocol such as HTTP or HTTPS, and by querying the network keyboard-object-resource repository through the application program interface (API), e.g., obtaining the water dripping sound effect file “s.mp3” of the input hot-zone corresponding to the “.com” key.

The generating module 13 generates the virtual input-keyboard based on the obtained one or more keyboard objects and their corresponding object-resource information, e.g., the generating module 13 associates the input hot-zone of the “.com” key with the water dripping sound effect file “s.mp3,” etc.

The providing module 14 provides the generated virtual input-keyboard to the user. The manner in which the providing module 14 provides the generated virtual input-keyboard to the user includes, but is not limited to, locally providing the information and providing it over a network.

Locally providing the information includes presenting the locally generated virtual input-keyboard on the display screen by invoking an application program interface (API) or by invoking a graphical user interface (GUI) so as to provide the virtual input-keyboard to the user.

Providing the information over the network includes presenting the generated virtual input-keyboard on the user-equipment display screen from the network in an agreed communication protocol, such as HTTP or HTTPS, via an application program interface (API) or a remote process call protocol (RPC) so as to provide the information to the user. User equipment includes various computers, smart phones, PDA, tablet computers, IPTV terminals, set top boxes, game machines, and similar devices.

In one example, the providing module 14 presents the generated virtual input-keyboard on the display screen by locally invoking the graphical user interface (GUI) so as to provide it to the user.

Preferably, the respective modules of the providing apparatus 1 cooperate continuously with each other. Specifically, the first obtaining-module 11 continuously obtains the keyboard-description information about the virtual input-keyboard that is to be provided to the user. Based on this information, the second obtaining-module 12 continuously obtains one or more keyboard objects corresponding to the virtual input-keyboard and object-resource information corresponding to each keyboard object. At least one of the one or more keyboard objects comprises an input hot-zone for receiving user-input operations to trigger corresponding input event(s). The generating module 13 continuously generates the virtual input-keyboard based on the one or more keyboard objects and object-resource information corresponding to each keyboard object. The providing module 14 continuously provides the generated virtual input-keyboard to the user.

The modules described above work continuously and constantly cooperate with each other. As used herein, “continuously” means that the above modules perform the operations of obtaining keyboard-description information about the virtual input-keyboard to be provided to the user, obtaining one or more keyboard objects corresponding to the virtual input-keyboard and the object-resource information corresponding to each keyboard object, generating the virtual input-keyboard, and providing the generated virtual input-keyboard to the user according to a preset or real-time adjusted work pattern, respectively, until the providing apparatus 1 stops obtaining the keyboard-description information about the virtual input-keyboard provided to the user.

Compared with the prior art, by obtaining corresponding one or more keyboard objects and the object-resource information corresponding to each keyboard object based on the keyboard-description information about the virtual input-keyboard, and generating and providing the virtual input-keyboard, the present invention makes it possible to adjust the user's virtual input-keyboard, thereby enhancing the input efficiency and improving the user experience.

Preferably, the generating module 13 comprises an adaptation unit and a generating unit. The adaptation unit is configured to use the predetermined object-adaptation-reference information to perform adaptation processing to the object-resource information to obtain the adapted object-resource information. The generating unit is configured to generate the virtual input-keyboard based on the one or more keyboard objects and the adapted object-resource information.

The predetermined object-adaptation-reference information includes any one or more of screen attribute information, object-occupancy information, and virtual input-keyboard layout information.

Screen attribute information includes information about a user's equipment. Examples of such information include the length and width of the screen of the server or the terminal used by the user.

Object-occupancy information includes information about a keypad object that corresponds to the object-resource information. Examples of such object-occupancy information about the keyboard object include key location, size of the key occupancy area, shape, and other similar information.

Virtual input-keyboard layout information includes information about the length and width information about the virtual input-keyboard, the location of the virtual input-keyboard, the number, kind, and location of keys of the virtual input-keyboard, and similar information.

The performance of adaptation processing includes, but is not limited to, performing adaptation processing to the virtual input-keyboard layout, performing adaptation processing to the object-occupancy information, and performing adaptation processing to the object-resource information.

Performing adaptation processing to the virtual input-keyboard layout includes doing so based on the screen attribute information. Examples include adapting the location, size, and shape of the virtual input-keyboard based on the screen size.

Performing adaptation processing to the object-occupancy information includes performing adaptation processing to the object-occupancy information about the keyboard object corresponding to the object-resource information based on the virtual input-keyboard layout information. Examples include, for example, when the size of the picture resource information corresponding to a key is larger than the occupancy area of the key on the virtual input-keyboard, scaling down the picture resource information proportionally such that the scaled-down picture resource information is consistent with the occupancy area of the key in the virtual input-keyboard.

Performing adaptation processing to the object-resource information includes doing so based on the user-customized adaptation rule so as to obtain the adapted object-resource information. An example of this would be implementing a user-customized adaptation rule to adapting the key into a triangle.

Another example of performing adaptation processing to the virtual input-keyboard resource information includes doing so based on predetermined virtual input-keyboard resolution adaptation reference information to generate the virtual input-keyboard. Examples of predetermined object-adaptation-reference information include information about keyboard resolution, screen resolution, and location of the input keyboard. More specific examples of such information include the fact that the resolution of the virtual keyboard is 240×400, the fact that the resolution of the screen is 480×800, the fact that the virtual input-keyboard is located at the bottom of the screen, the fact that the resolution of the virtual input-keyboard resource information is 480×800, and the fact that the adaption unit performs adaptation processing to the virtual input-keyboard resource information based on the predetermined virtual input-keyboard resolution adaptation reference information. An example of the latter would include scaling down the resolution of the virtual input-keyboard resource information 480×800 into half of the original resolution, thereby obtaining a resolution of 240×400 for the adapted virtual input-keyboard resource information. The generating unit generates the virtual input-keyboard based on the one or more keyboard objects and the adapted virtual input-keyboard resource information.

Current methods for implementing a virtual input-keyboard generally have several problems.

One such problem is that it is difficult to guarantee a uniform appearance of the virtual input-keyboard on various platforms. Another such problem is that, for different system platforms, a corresponding set of products will be developed with respect to each virtual input-keyboard. Apparently, because each virtual input-keyboard has many platform versions, it is hard to guarantee uniform appearance of the virtual input-keyboard on all platforms. For example, the limited screen size of a mobile terminal may make it impossible for the appearance of the virtual input-keyboard developed on the mobile portable terminal to look like the corresponding virtual input-keyboard of a desktop computer. As another example, a virtual input-keyboard resource, such as a skin resource, of the virtual input-keyboard developed for a desktop computer platform likely occupies a large memory space. As a result, such resources may not be directly usable on the virtual input-keyboard of the portable terminal without adaptation.

By performing adaptation processing to the object-resource information based on information such as the screen attribute of the user equipment, the apparatus described herein enables the virtual input-keyboard to maintain a uniform appearance on different platforms. This not only overcomes the above problem, but also avoids deterioration of the user's input efficiency that may arise as a result of differences in keyboard layout that result from platform differences. This further enhances the user's input efficiency and promotes the user's input experience.

In one embodiment, the providing device 1 further comprises a third obtaining-module, a performing module, and a displaying module. The third obtaining-module is configured to obtain the user's input operation on the input hot-zone. The performing module is configured to perform a keyboard input operation corresponding to the input hot-zone based on the input operation. The displaying module is configured to provide, to the user, the result of performing the keyboard input operation.

For example, the input hot-zone corresponding to the “A” key of the virtual input-keyboard may cause display of an “A” and playing a sound specified by the sound-effect information, such as the sound of water dripping. When the user clicks on the “A” key of the virtual input-keyboard, the third obtaining-module obtains information that the user has clicked on the “A” key. The performing module then performs a keyboard input operation corresponding to the input hot-zone based on the input hot-zone corresponding to the virtual input-keyboard “A.” For example, the display information causes display of an “A” and the sound-effect information causes playing of an appropriate sound, such as the sound of water dripping. The displaying module provides the result of performing the keyboard input operation on the “A” key to the user, for example by displaying the “A” on the screen and playing the sound of water dripping, which corresponds to the sound-effect information.

In some embodiments, the providing apparatus 1 provides input-prompt information corresponding to the input hot-zone to the user based on the input operation. The input-prompt information includes either sound-effect information corresponding to either the input hot-zone and/or display-information corresponding to the input hot-zone.

For example, the input-prompt information for the input hot-zone corresponding to the “A” key of the virtual input-keyboard includes display-information indicating that the “A” key is to slide from the top of the screen to a text input box of the virtual input-keyboard, and sound-effect information indicating that the sound of a drum is to be played. The user clicks onto “A” key of the virtual input-keyboard. The third obtaining-module then determines that the user has clicked on the “A” key. The performing module performs a keyboard input operation corresponding to the input hot-zone based on the input hot-zone corresponding to the virtual input-keyboard's “A” key. For example, the input-prompt information corresponding to the “A” key's input hot-zone includes display-information indicating that the “A” key is to slide from the top of the screen to a text input box of the virtual input-keyboard and sound-effect information “drum sound.” The displaying module provides the “A” key and the input-prompt information corresponding to the input hot-zone to the user. This might include, for example, displaying the display information by causing the “A” key to slide from the top of the screen to a text input box of the virtual input-keyboard and displaying sound-effect information by playing the sound of a drum.

In one embodiment, the second obtaining-module 12 comprises a keyboard-object-obtaining unit and an object-resource-information-obtaining unit.

The keyboard-object-obtaining unit is configured to obtain the one or more keyboard objects based on the keyboard-description information. At least one of the one or more keyboard objects comprises an input hot-zone for receiving user-input operation to trigger one or more corresponding input events.

The object-resource information obtaining unit is configured to obtain the object-resource information corresponding to the keyboard object based on the keyboard object.

For example, the keyboard-description information includes: the path information for storing the virtual input-keyboard in a local database of the providing apparatus 1; the path information for storing respective keys on the virtual input-keyboard and the skins in a local database of the providing apparatus 1; the path information for storing the input-prompt information corresponding to the input hot-zone in a local database of the providing apparatus 1, etc.; the keyboard-object-obtaining unit obtains, based on the keyboard-description information, the path information for storing the virtual input-keyboard, the path information for storing respective keys on the virtual input-keyboard and the skins, and the path information for storing the input-prompt information corresponding to the input hot-zone; the object-resource information obtaining unit obtains, based on the keyboard object, the virtual input-keyboard object-resource information, the object-resource information for the respective keys on the virtual input-keyboard and the skins, and the object-resource information corresponding to the input-prompt information corresponding to the input hot-zone from the local database, through the API of the local database of the providing device 1 or through a function call.

In some embodiments, the object-resource-information-obtaining unit obtains object-resource-combination information that is generated by combining candidate object-resource information for generating the virtual input-keyboard, and extracts the object-resource information corresponding to the keyboard object from the object-resource-combination information based on the keyboard object.

The object resource combination includes the result of combining one or more object resources into an object resource through a combining algorithm.

The object-resource-information-obtaining unit may obtain or read into the memory a plurality of items of object-resource information in one operation.

An example of obtaining picture-resource-combining information, and extracting the object-resource information corresponding to the keyboard object from the object-resource-combination information is as follows.

Consider a picture resource M that is generated by nine candidate pictures M1-M9 for generating a virtual input-keyboard through performing a minimal size combination. The object-resource-information-obtaining unit obtains object resource combining information indicating that the picture resource M is object-resource-combination information formed by nine candidate pictures M1-M9 for generating a virtual input-keyboard, and obtains the candidate pictures M1-M9 object-resource information from a local database based on the keyboard object through the API of the local database of the providing apparatus 1 or a function call.

The embodiment described herein further enhances the communication or read efficiency by combining relevant resource information and obtaining or reading into the memory in one memory operation.

In some embodiments, the object-resource-information-obtaining unit is configured to perform a match query in a keyboard-object-resource repository based on the keyboard object so as to obtain the object-resource information corresponding to the keyboard object.

The keyboard-object-resource repository includes, but is not limited to, a software packet included in the virtual input-keyboard, and a resource database included at the local and/or network end.

For example, based on the keyboard object “.com,” match querying is performed in the software packet of the virtual input-keyboard to obtain the object-resource information corresponding to the keyboard object, e.g., the object-resource information corresponding to “.com” includes a picture file “a” and sound-effect file “b.” The object-resource-information-obtaining unit performs a match query in the software packet of the virtual input-keyboard through a function call. If the picture file “a” and the sound effect file “b” are stored in the software packet of the virtual input-keyboard, the obtain resource-information-obtaining unit obtains the picture file “a” and the sound effect file “b” corresponding to the keyboard object.

FIG. 2 shows a schematic diagram of an apparatus for providing a virtual input-keyboard according to one preferred embodiment of the present invention. In particular, FIG. 2 shows a first obtaining-module 11′ that obtains keyboard-description information for a virtual input board that is to be provided to a user. FIG. 2 also shows a second obtaining-module 12′ that, based on the keyboard-description information, obtains one or more keyboard objects corresponding to the virtual input-keyboard and object-resource information corresponding to each keyboard object. At least one of the one or more keyboard objects comprises an input hot-zone for receiving user-input operations to trigger one or more corresponding input events. FIG. 2 also shows a generating module 13′ that generates the virtual input-keyboard based on the obtained one or more keyboard objects and the object-resource information corresponding to each keyboard object. Also shown in FIG. 2 is a providing module 14′ that provides the generated virtual input-keyboard to the user, a fourth obtaining-module 15′ that obtains the user's keyboard-adjustment operation on the virtual input-keyboard, and an updating module 16′ that, based on the keyboard-adjustment operation, updates one or more keyboard objects of the virtual input-keyboard and object-resource information corresponding to each keyboard object. The first obtaining-module 11′, the second obtaining-module 12′, the generating module 13′, and the providing module 14′ are identical or similar to the corresponding apparatus in FIG. 1, and will therefore not be detailed here, but are incorporated here by reference.

The fourth obtaining-module 15′ obtains the user's keyboard-adjustment operation on the virtual input-keyboard.

The keyboard-adjustment operation comprises at least any one of: adjusting location information of at least one of the one or more keyboard objects; adjusting shape information of at least one of the one or more keyboard objects; adjusting the input event(s) corresponding to the input hot-zone; and adjusting object-resource information corresponding to at least one of the one or more keyboard objects.

Adjusting location information of at least one of the one or more keyboard objects includes an adjustment, by a user, of a keyboard object location of a virtual input-keyboard. For example, the user may swap the positions of the “B” key and the “A” key. Or the user may move the position of “B” key to a blank position, which is a position on the virtual input-keyboard without a key.

Adjusting shape information of at least one of the one or more keyboard objects can include, for example, adjustment by the user of a shape of a keyboard object of the virtual input-keyboard. For example, the user may change the shape of the “A” key from being a rectangle to being round, or to being irregularly shaped.

Adjusting an input event corresponding to the input hot-zone can include, for example, changing the input information and prompt information corresponding to the key. An example would be adjusting the “.com” key to the “.net” key. Another example is changing sound-effect information. For example, the user may change the sound-effect information corresponding to the “A” key from the sound of a drum to the sound of water dripping.

Adjusting object-resource information corresponding to at least one of the one or more keyboard objects can include, for example, varying the picture and sound effect files corresponding to the keyboard object. An example of this is changing the user's picture for the “A” key from red to blue, or changing the sound effect file corresponding to “A” from a first sound effect file “a” to a second sound effect file “b.”

In one example, the fourth obtaining-module 15 obtains the user's “.com” adjusting operation on the virtual input-keyboard.

In another example, the user: adjusts the position of the “.com” key from the left bottom corner of the virtual input-keyboard to the left upper corner; adjusts the shape of the “.com” key from being rectangular to being round; adjusts the input event (e.g., the sound-effect information) corresponding to the input hot-zone of the “.com” key from being the sound of water dripping to the sound of a drum; and adjusts the resource information for the “.com” key from being the file “r” to the file “p.”

The updating module 16′ based on the keyboard-adjustment operation updates one or more keyboard objects of the virtual input-keyboard and object-resource information corresponding to each keyboard object. The providing apparatus 1 carries out the operations performed by the generating module 13′ and the providing module 14′ based on the updated one or more keyboard objects of the virtual input-keyboard and object-resource information corresponding to each keyboard object.

For example, in response to the user changing the rectangular “space key” on the virtual input-keyboard into a round key, the fourth obtaining-module 15′ determines that the user needs to perform a keyboard-adjustment operation to change the rectangular “space key” on the virtual input-keyboard into a round key. Then, the updating module 16′ updates the “space key” keyboard object of the virtual input-keyboard and the corresponding object-resource information. The generating module 13′ then determines the object-resource information for the “space key” of the updated virtual input-keyboard, and generates the virtual input-keyboard. Finally, the providing module 14′ provides the virtual input-keyboard to the user.

Re-generating and providing the updated virtual input-keyboard based on the user's adjustment operation on the virtual input-keyboard enables the embodiment described herein to further enhance the user's input efficiency and to improve the user's input experience.

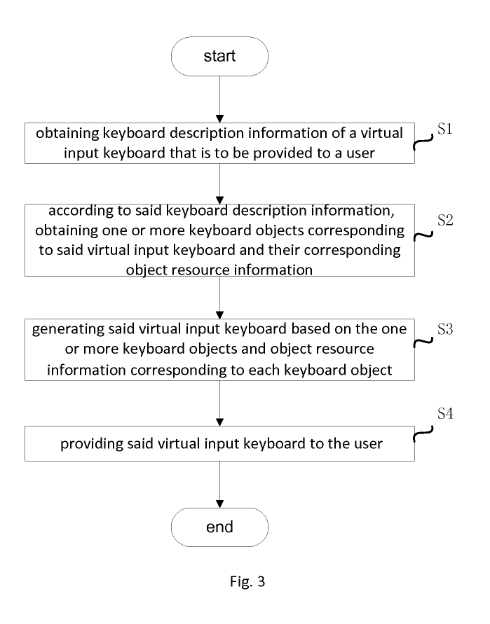

FIG. 3 shows a flow diagram of a computer-implemented method for providing a virtual input-keyboard according to one aspect of the present invention.

In FIG. 3, the providing apparatus 1 implementing the method comprises a server and a terminal. When the providing apparatus 1 comprises a server, the providing device 1 includes, but is not limited to, a single host machine, a small machine, a large machine, a plurality of host clusters, a network host machine, a single network server, a plurality of network server clusters, or a cloud composed of a plurality of servers. When the providing apparatus 1 comprises a terminal, the providing device 1 is any terminal that can perform human-machine interaction with the user through a virtual input-keyboard. Examples of such terminals include various kinds of computer, smart phones, PDAs, tablet computers, IPTV terminals, set top boxes, and game machines.

In the illustrated embodiment, the providing apparatus 1 comprises a server and a terminal.

When the providing apparatus 1 comprises a server, the providing device 1 includes, but is not limited to, a single host machine, a small machine, a large machine, a plurality of host clusters, a network host machine, a single network server, a plurality of network server clusters, or a cloud composed of a plurality of servers. When the providing apparatus 1 comprises a terminal, the providing device 1 is any terminal that can perform human-machine interaction with the user through a virtual input-keyboard. Examples include various kinds of computers, smart phones, PDAs, tablet computers, IPTV terminals, set top boxes, and game machines.

In step S1, the providing apparatus 1 obtains keyboard-description information of a virtual input-keyboard that is to be provided to a user. Obtaining the keyboard-description information includes, but is not limited to, obtaining relevant resource information and obtaining virtual input-keyboard layout information.

Examples of relevant resource information include length and width information of a display screen for displaying a virtual input-keyboard, various keys on the virtual input-keyboard, and path information for storing skins Examples of virtual input-keyboard layout information include length and width information of the virtual input-keyboard, location information of the virtual input-keyboard, numbers, kinds, and location information of keys of the virtual input-keyboard.

The manner of obtaining the keyboard-description information includes but is not limited to, obtaining it locally and obtaining it from the Internet.

Obtaining the information locally includes obtaining keyboard-description information of a virtual input-keyboard to be provided to the user from the local through an application program interface (API), or by invoking a function, or from a local keyboard-description information repository that is used to store keyboard-description information of the virtual input-keyboard.

Obtaining the information from the Internet includes obtaining keyboard-description information of the virtual input-keyboard to be provided to the user from the Internet through an application program interface (API), through a remote process call protocol (RPC), through a network keyboard-description information repository that is used to store keyboard-description information of the virtual input-keyboard, or using an agreed upon communication protocol such as HTTP, or HTTPS.

In step S1, the providing apparatus 1 locally obtains keyboard-description information of the virtual input-keyboard to be provided to the user. When the virtual input-keyboard is actuated, in step S1, the providing apparatus 1 locally obtains keyboard-description information of the virtual input-keyboard to be provided to the user through querying a local keyboard-description information repository. Examples of such information include the fact that the size of the virtual input-keyboard is 90×120, the fact that its location is to be the bottom of the display screen, and the path information for storing resources corresponding to respective keys on the virtual input-keyboard.

In step S2, the providing apparatus 1, based on the keyboard-description information, obtains one or more keyboard objects corresponding to the virtual input-keyboard and object-resource information corresponding to each keyboard object. At least one of the one or more keyboard objects comprises an input hot-zone for receiving user-input operations to trigger corresponding input event(s). As used herein, “more” means two or more.

In some embodiments, the keyboard object comprises the type, size, skin, display area, and input hot-zone of the keys on the virtual input-keyboard. This includes the fact that the key is rectangular, that's is size is 25×20 pixels, that its skin is red, that the display area is at the bottom of the display screen, and that the input hot-zone sound-effect is the sound of dripping water.

The input hot-zone triggers a corresponding input operation based on the received user-input operation. The corresponding input operation includes display information and sound-effect information. For example, the information may specify that when a user clicks on the input hot-zone corresponding to the “.com” key, the virtual input-keyboard will emit a sound effect that sounds like dripping water.

In some embodiments, the object-resource information comprises a picture file, a sound-effect file, and the like corresponding to each keyboard object.

The manner of obtaining one or more keyboard objects corresponding to the virtual input-keyboard and object-resource information corresponding to each keyboard object includes, but is not limited to, obtaining the information locally and obtaining them using the Internet.

Obtaining the information locally includes obtaining keyboard-description information of a virtual input-keyboard to be provided to the user locally through an application program interface (API), by invoking a function, or by using a local keyboard-object-resource repository, that is used for storing the keyboard object and its corresponding object-resource information.

Obtaining it from the Internet includes obtaining the keyboard-description information of the virtual input-keyboard to be provided to the user from the Internet, through an application program interface (API), through a remote process call protocol (RPC), or through a network keyboard-object-resource repository that is used for storing the keyboard object and its corresponding object-resource information, or using agreed-upon communication protocol such as HTTP or HTTPS.

For example, in step S2, the providing apparatus 1 obtains, from the network, one or more keyboard objects corresponding to the virtual input-keyboard and the corresponding object-resource information for the one or more keyboard objects. When the virtual input-keyboard is actuated, in step S1, the providing apparatus 1 obtains, from the network, keyboard-description information for the virtual input-keyboard to be provided to the user. It does so using an agreed upon communication protocol, such as HTTP or HTTPS, by querying a network keyboard-object-resource repository via an application program interface (API). Examples of such information include the fact that the size of the virtual input-keyboard is 90×120, that the location is at the bottom of the display screen, and that the path information for storing resources corresponding to respective keys on the virtual input-keyboard is the network keyboard-object-resource repository.

In step S2, the providing apparatus 1 obtains, from the network, one or more keyboard objects corresponding to the virtual input-keyboard and the corresponding object-resource information based on the obtained keyboard-description information. It does so using an agreed upon communication protocol, such as HTTP or HTTPS, and by querying the network keyboard-object-resource repository through an application program interface (API). Examples include obtaining the sound-effect file “s.mp3” of the input hot-zone corresponding to the “.com” key.

In step S3, the providing apparatus 1 generates the virtual input-keyboard based on the obtained one or more keyboard objects and object-resource information corresponding to each keyboard object.

In one example, the virtual input-keyboard is generated based on the one or more keyboard objects and the object-resource information corresponding to each keyboard object obtained from the network.

In step S1, the providing apparatus 1 obtains, from the network, keyboard-description information of the virtual input-keyboard to be provided to the user in an agreed upon communication protocol, such as HTTP or HTTPS, by querying a network keyboard-object-resource repository via an application program interface (API). Such keyboard-description information can include, for example, the fact that the size of the virtual input-keyboard is 90×120, the fact that its location is at the bottom of the display screen, and the fact that the path information for storing resources corresponding to respective keys on the virtual input-keyboard leads to the network keyboard-object-resource repository.

In step S2, the providing apparatus 1 obtains, from the network, one or more keyboard objects corresponding to the virtual input-keyboard and their corresponding object-resource information based on the obtained keyboard-description information in an agreed upon communication protocol, such as HTTP or HTTPS, and by querying the network keyboard-object-resource repository through the application program interface (API), e.g., obtains the water dripping sound-effect file “s.mp3” of the input hot-zone corresponding to the “.com” key.

In step S3, the providing apparatus 1 generates the virtual input-keyboard based on the obtained one or more keyboard objects and their corresponding object-resource information. For example, in step S3, the providing apparatus 1 associates the input hot-zone of the “.com” key with the water dripping sound effect file “s.mp3.”

In step S4, the providing apparatus 1 provides the generated virtual input-keyboard to the user.

The manner in which, in step S4, the providing apparatus 1 provides the generated virtual input-keyboard to the user includes providing it locally and providing it via a network.

Providing the generated keyboard locally includes presenting the locally generated virtual input-keyboard on the display screen by invoking an application program interface (API) or by invoking a graphical user interface (GUI) so as to provide it to the user.

Providing via a network includes presenting the generated virtual input-keyboard on the user equipment display screen from the network using an agreed-upon communication protocol, such as HTTP or HTTPS via an application program interface (API) or a remote process call protocol (RPC) so as to provide it to the user. The user equipment can include includes various computers, smart phones, PDAs, tablet computers, IPTV terminals, set top boxes, and game machines.

In step S4, the providing apparatus 1 presents the generated virtual input-keyboard on the display screen by invoking the graphical user interface (GUI) via local provision, so as to provide it to the user.

Preferably, the steps carried out by the providing apparatus 1 are carried out continuously. Specifically, in step S1, the providing apparatus 1 continuously obtains the keyboard-description information of the virtual input-keyboard that is to be provided to the user. In step S2, the providing apparatus 1, based on the keyboard-description information, continuously obtains one or more keyboard objects corresponding to the virtual input-keyboard and object-resource information corresponding to each keyboard object. At least one of the one or more keyboard objects comprises an input hot-zone for receiving user-input operations to trigger corresponding input event(s). In step S3, the providing apparatus 1 continuously generates the virtual input-keyboard based on the one or more keyboard objects and object-resource information corresponding to each keyboard object. And in step S4, the providing apparatus 1 continuously provides the generated virtual input-keyboard to the user. The above respective modules work continuously and constantly cooperate with each other. As used herein, “continuously” means that the above steps perform obtaining keyboard-description information of the virtual input-keyboard to be provided to the user, obtaining one or more keyboard objects corresponding to the virtual input-keyboard and the object-resource information corresponding to each keyboard object, generating the virtual input-keyboard, and providing the generated virtual input-keyboard to the user according to a preset or real-time adjusted work pattern, respectively until the providing apparatus 1 stops obtaining the keyboard-description information of the virtual input-keyboard provided to the user.

Compared with the prior art, by obtaining corresponding one or more keyboard objects and the object-resource information corresponding to each keyboard object based on the keyboard-description information of the virtual input-keyboard, and generating and providing the virtual input-keyboard, the methods and systems described herein make it possible to adjust a user's virtual input-keyboard, and thereby enhance the user's input efficiency and improve the user's experience.

In some embodiments, the step S3 includes, based on the predetermined object-adaptation-reference information, performing adaptation processing to the object-resource information to obtain the adapted object-resource information, and generating the virtual input-keyboard based on the one or more keyboard objects and the adapted object-resource information.

The predetermined object-adaptation-reference information includes at least any one of screen attribute information of a user's equipment, object-occupancy information of a keypad object, and virtual input-keyboard layout information.

Screen attribute information of a user's equipment can include such things as the length and width information of the screen of the server or the terminal used by the user.

Object-occupancy information of a keypad object corresponding to the object-resource information can include such things as key location, size of the key occupancy area, shape, and other information.

Virtual input-keyboard layout information includes, for example, the length and width information of the virtual input-keyboard, location information of the virtual input-keyboard, the number, kind, and location information of keys of the virtual input-keyboard, etc.

Adaptation processing includes, but is not limited to, performing adaptation processing to the virtual input-keyboard layout based on the screen attribute information. Examples include adapting the location, size, and shape of the virtual input-keyboard based on the screen size.

Another example includes performing adaptation processing to the object-occupancy information of the keyboard object corresponding to the object-resource information based on the virtual input-keyboard layout information. An example would be, when the size of the picture resource information corresponding to a key is larger than the occupancy area of the key on the virtual input-keyboard, scaling down the picture resource information proportionally such that the scaled-down picture resource information is consistent with the occupancy area of the key in the virtual input-keyboard.

Another example includes performing adaptation processing to the object-resource information based on the user-customized adaptation rule so as to obtain the adapted object-resource information, e.g., the user-customized adaptation rule is adapting the key into a triangle.

For example, performing adaptation processing to the virtual input-keyboard resource information can include doing so based on predetermined virtual input-keyboard resolution adaptation reference information to generate the virtual input-keyboard. Examples of such predetermined object-adaptation-reference information include information indicating that: the resolution of the virtual keyboard is 240×400, the resolution of the screen is 480×800, and that the virtual input-keyboard is located at the bottom of the screen. the resolution of the virtual input-keyboard resource information is 480×800. The providing apparatus 1 performs adaptation processing to the virtual input-keyboard resource information based on the predetermined virtual input-keyboard resolution adaptation reference information. This can include, for example, scaling down the resolution of the virtual input-keyboard resource information 480×800 into ½ of the original resolution, thereby determining that the resolution of the adapted virtual input-keyboard resource information is 240×400. The providing apparatus 1 generates the virtual input-keyboard based on the one or more keyboard objects and the adapted virtual input-keyboard resource information.

The current implementation methods of a virtual input-keyboard generally have a plurality of problems: for example, it is difficult to guarantee a uniform appearance of the virtual input-keyboard on various platforms. For example, for different system platforms, a corresponding set of products will be developed with respect to each virtual input-keyboard. Apparently, because each virtual input-keyboard has many platform versions, it is hard to guarantee uniform appearance of the virtual input-keyboard on respective platforms, e.g., the appearance of the virtual input-keyboard developed on the mobile portable terminal, due to its limited screen size, might be unable to be uniform in appearance with the corresponding virtual input-keyboard of a desktop compute. For another example, the repeated utilization of the virtual input-keyboard resource is not high, such as, for skin resources of the virtual input-keyboard developed for a desktop computer platform likely occupies a larger memory space, while these skin resources are likely unable to be directly used on the virtual input-keyboard of the portable terminal without certain adaptation.

By performing adaptation processing to the object-resource information based on information such as screen attribute of the user equipment, the present embodiment enables the virtual input-keyboard to maintain a uniform appearance on different platforms, which not only overcomes the above problem, but also avoids deterioration of the user's input efficiency due to keyboard layout difference caused by platform differences, which further enhances the user's input efficiency and promotes the user's input experience.

Preferably, the method further includes a step S10 of obtaining the user's input operation on the input hot-zone, a step S11 of performing a keyboard input operation corresponding to the input hot-zone based on the input operation, and a step S12 of providing the result of performing the keyboard input operation to the user.

In one example, the input hot-zone corresponding to the “A” key of the virtual input-keyboard displays “A” and plays the sound of water dripping as a sound effect. When the user clicks on the “A” key, the providing apparatus 1 determines that the user has clicked on the “A” key (step S10). Then, in step S11, the providing apparatus 1 performs a keyboard-input operation corresponding to the input hot-zone based on the input hot-zone corresponding to the virtual input-keyboard's “A” key. This would include displaying an “A” and emitting a sound corresponding to the sound-effect information, such as the sound of dripping water. In step S12, the providing apparatus 1 provides the result of performing the keyboard-input operation on the “A” key to the user. This result includes, for example, displaying an “A” on the screen and emitting the sound corresponding to the sound-effect information, such as the sound of dripping water.

More preferably, the providing apparatus 1 provides input-prompt information corresponding to the input hot-zone to the user based on the input operation. The input-prompt information includes either or both sound-effect information corresponding to the input hot-zone and display information corresponding to the input hot-zone.

For example, the input-prompt information for the input hot-zone corresponding to the “A” key of the virtual input-keyboard includes display information indicating that the “A” key is to slide from the top of the screen to a text input box of the virtual input-keyboard” and that sound-effect information indicating that the sound of a drum is to be played when the user clicks on the “A” key of the virtual input-keyboard. In step S10, the providing apparatus 1 determines that the user has clicked on the “A” key. In step S11, the providing apparatus 1 performs a keyboard input operation corresponding to the input hot-zone based on the input hot-zone corresponding to the virtual input-keyboard's “A” key. For example, the input-prompt information corresponding to the “A” key's input hot-zone includes display information indicating that the “A” key is to slide from the top of the screen to a text input box of the virtual input-keyboard and that the sound-effect information indicating that the sound of a drum is to be played. In step S12, the providing apparatus 1 provides the “A” key and the input-prompt information corresponding to the input hot-zone to the user. This includes displaying the “A” key sliding from the top of the screen to a text input box of the virtual input-keyboard and playing the sound of a drum.

Preferably, the step S2 comprises obtaining the one or more keyboard objects based on the keyboard-description information and at least one of the one or more keyboard objects comprising an input hot-zone for receiving user-input operation to trigger corresponding input event(s); and obtaining the object-resource information corresponding to the keyboard object based on the keyboard object.

An example of keyboard-description information includes the fact that the path information for storing the virtual input-keyboard leads to a local database of the providing apparatus 1; that the path information for storing respective keys on the virtual input-keyboard and the skins leads to a local database of the providing apparatus 1; that the path information identifying a location for storing the input-prompt information corresponding to the input hot-zone leads to a local database of the providing apparatus 1, and so on.

In step S2a, the providing apparatus 1 obtains, based on the keyboard-description information, the path information for storing the virtual input-keyboard, the path information for storing respective keys on the virtual input-keyboard and for storing the skins, and the path information for storing the input-prompt information corresponding to the input hot-zone.

In step S2b, the providing apparatus 1 obtains, based on the keyboard object, the virtual input-keyboard object-resource information, the object-resource information for the respective keys on the virtual input-keyboard and for the skins, and the object-resource information corresponding to the input-prompt information corresponding to the input hot-zone from the local database, through the API of the local database of the providing device 1 or through a function call.

In step S2b, the providing apparatus 1 is configured to obtain object-resource-combination information and to extract the object-resource information corresponding to the keyboard object from the object-resource-combination information based on the keyboard object. The object-resource-combination information is generated by combining candidate object-resource information for generating the virtual input-keyboard. Forming the object resource combination includes combining one or more object resources into an object resource through a combining algorithm.

In step S2b, the providing apparatus 1 may obtain or read into the memory a plurality of items of object-resource information all at once.

Examples of obtaining picture resource combining information, and extracting the object-resource information corresponding to the keyboard object from the object-resource-combination information include generating a picture resource M using nine candidate pictures M1-M9 for generating a virtual input-keyboard through performing a minimal size combination.

In step S2b, the providing apparatus 1 obtains the object resource combining information that indicates that the picture resource M is object-resource-combination information formed by nine candidate pictures M1-M9 for generating a virtual input-keyboard, and obtains the candidate pictures M1-M9 object-resource information from a local database based on the keyboard object through the API of the local database of the providing device 1 or through a function call.

The embodiment described herein further enhances the communication or read efficiency by combining relevant resource information and obtaining or reading into the memory all at once.

In one embodiment, in step S2b, the providing apparatus 1 is configured to perform a match query in a keyboard-object-resource repository based on the keyboard object so as to obtain the object-resource information corresponding to the keyboard object. The keyboard-object-resource repository includes, but is not limited to, a software packet included in the virtual input-keyboard, and a resource database included at a local and/or network end. For example, based on the keyboard object “.com,” match querying is performed in the software packet of the virtual input-keyboard to obtain the object-resource information corresponding to the keyboard object. Such match querying includes, for example, determining that the object-resource information corresponding to “.com” includes a picture file “a” and a sound-effect file “b”.

In one embodiment, in step S2b, the providing apparatus 1 performs a match query in the software packet of the virtual input-keyboard through a function call. If the picture file “a” and the sound effect file “b” are stored in the software packet of the virtual input-keyboard, the object-resource-information-obtaining unit obtains the picture file “a” and the sound effect file “b” corresponding to the keyboard object.

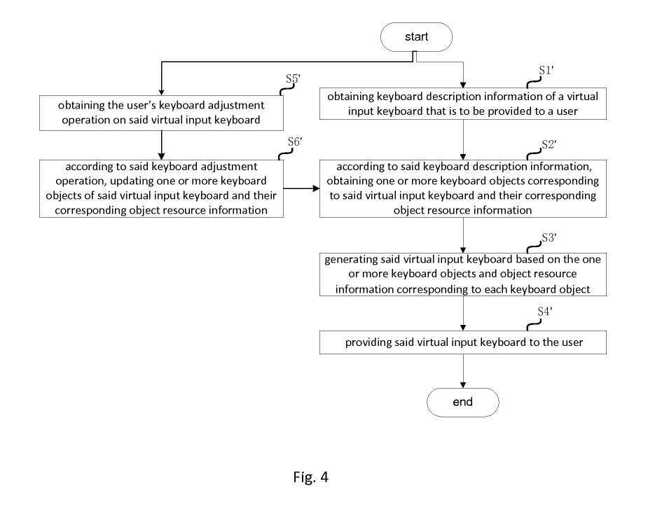

FIG. 4 shows a flow diagram of a computer-implemented method for providing a virtual input-keyboard.

In step S1′, the providing apparatus 1 obtains keyboard-description information of a virtual input-keyboard that is to be provided to a user.

In step S2′, the providing apparatus 1 uses the keyboard-description information to obtain one or more keyboard objects corresponding to the virtual input-keyboard and to obtain object-resource information corresponding to each keyboard object. At least one of the one or more keyboard objects comprises an input hot-zone for receiving user-input operations to trigger corresponding input event(s).

In step S3′, the providing apparatus 1 generates the virtual input-keyboard based on the obtained one or more keyboard objects and the object-resource information corresponding to each keyboard object.

In step S4′, the providing apparatus 1 provides the generated virtual input-keyboard to the user. In step S5′, the providing apparatus 1 obtains the user's keyboard-adjustment operation on the virtual input-keyboard. And in step S6′, the providing apparatus 1 uses the keyboard-adjustment operation in connection with updating one or more keyboard objects of the virtual input-keyboard and object-resource information corresponding to each keyboard object.

In FIG. 4, step S1′, step S2′, step S3′, and step S4′ are identical or similar to the corresponding steps in FIG. 3. The detailed description of those steps will not be repeated here, and is instead incorporated herein by reference.

Specifically, in step S5′, the providing apparatus 1 obtains the user's keyboard-adjustment operation on the virtual input-keyboard. The keyboard-adjustment operation comprises at least any one of: adjusting location information of at least one of the one or more keyboard objects; adjusting shape information of at least one of the one or more keyboard objects; adjusting the input event(s) corresponding to the input hot-zone; and adjusting object-resource information corresponding to at least one of the one or more keyboard objects.

There are many ways to carry out adjustment of location information of at least one of the one or more keyboard objects, some examples of which follow.

In a first example, a user adjusts a keyboard object location of a virtual input-keyboard. For example, the user may swap the positions of the “B” key and the “A” key. Or, the user may decided to move the position of the “B” key to a blank position, which is a position on the virtual input key that has no key disposed thereon.

In a second example, a user adjusts shape information of at least one of the one or more keyboard objects. For example, the user may adjust the shape of a keyboard object of the virtual input-keyboard. One example of this would be the user changing the “A” key from being rectangular to being round, or irregularly shaped.

Examples of adjusting an input event corresponding to the input hot-zone include changing the input information and prompt information corresponding to a key, such as changing the “.com” key to a “.net” key, or changing sound-effect information corresponding to the “A” key from the sound of a drum to the sound of dripping water.

Adjusting object-resource information corresponding to at least one of the one or more keyboard objects can also include varying the picture and sound effect files corresponding to the keyboard object. An example would be changing the user's picture for the “A” key from red to blue, or changing the sound-effect file corresponding to the “A” key from the sound-effect file “a” to the sound-effect file “b.”

In another example, the fourth obtaining-module 15 obtains the user's “.com” adjusting operation on the virtual input-keyboard. This information can include, for example, an adjustment by the user of the position of the “.com” key from the left bottom corner of the virtual input-keyboard to the left upper corner, an adjustment of the shape of the “.com” key from being rectangular to being round, and an adjustment of the input event, such as the sound-effect information, that corresponds to the input hot-zone of the “.com” key, for example from being the sound of water dripping to the sound of a drum, and an adjustment of the resource information for the “.com” key from the a first file “r” to a second file “p.”

In step S6′, the providing apparatus 1, based on the keyboard-adjustment operation, updates one or more keyboard objects of the virtual input-keyboard and object-resource information corresponding to each keyboard object. The providing apparatus 1 performs the operations performed by in steps S3′ and S4′ based on the updated one or more keyboard objects of the virtual input-keyboard and object-resource information corresponding to each keyboard object.

In one example, the user changes the rectangular “space key” on the virtual input-keyboard from being round. In step S5′, the providing apparatus 1 determined that the user needs to perform a keyboard-adjustment operation to change the rectangular “space key” on the virtual input-keyboard into a round key. In step S6′, the providing apparatus 1 updates the “space key” keyboard object of the virtual input-keyboard and the corresponding object-resource information. In step S3, the providing apparatus 1′ obtains the object-resource information for the “space key” of the updated virtual input-keyboard, and generates the virtual input-keyboard. Then, in step S4, the providing apparatus 1 provides the virtual input-keyboard to the user.

By re-generating and providing the updated virtual input-keyboard based on the user's adjustment operation on the virtual input-keyboard, the apparatus' and methods described herein further enhance the user's input efficiency and improve the user's input experience.

The details of the methods and apparatus' described herein are not intended to limit the scope of the invention. The present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. The term “comprise” does not exclude other units or steps, and singularity does not exclude plurality. Any references in the claims to plural units or modules can also be implemented by a single unit or module through hardware or through software that is executing on particular hardware. Adjectives that take the form of ordinal numbers, such as “first” and “second,” are used to indicate names, and do not indicate any particular sequence.

To the extent claims can be construed as covering both hardware and software per-se, implementations that are regarded as software per-se are specifically excluded.

To the extent claims can be construed as implementing or reciting both abstract and non-abstract embodiments, abstract embodiments are specifically excluded from the claims.

To the extent claims can be construed as implementing or reciting subject matter that is both within the scope of statutory subject matter as defined by 35 USC 101 as of the filing date of this application and outside the scope, the claims are hereby deemed to exclude the latter and to include only the former.

A variety of method and systems have been described for carrying out various procedures. It is understood that these are provided as examples only, and that there are other existing methods and systems that are equivalent and applicable. Such systems and methods are intended to be covered by the pertinent claims that follow.

In addition, it is foreseeable that additional methods and systems that have not yet been developed for performing the foregoing tasks. To the extent these yet-to-be developed systems are equivalent to those described herein, they too are intended to be covered by the pertinent claims that follow.

Having described the invention, and a preferred embodiment thereof, what is claimed as new, and secured by Letters Patent is:

1-20. (canceled)

21. A computer-implemented method for communicating with a computer, said method comprising providing a virtual input-keyboard, wherein providing a virtual input-keyboard comprises obtaining keyboard-description information for a virtual input-keyboard that is to be provided to a user, based at least in part on said keyboard-description information, obtaining one or more keyboard objects corresponding to said virtual input-keyboard and object-resource information corresponding to each keyboard object, wherein at least one of said keyboard objects comprises an input hot-zone for receiving user input-operations that trigger at least one corresponding input event, generating said virtual input-keyboard based at least in part on said one or more keyboard objects and said object-resource information corresponding to each keyboard object; and providing said virtual input-keyboard to the user.

22. The method of claim 21, wherein the generating said virtual input-keyboard comprises, according to predetermined object-adaptation-reference information, performing adaptation processing to said object-resource information to obtain the adapted object-resource information, and generating said virtual input-keyboard based at least in part on said one or more keyboard objects and said adapted object-resource information.

23. The method of claim 22, wherein said predetermined object-adaptation-reference information is selected from the group consisting of a screen attribute of user equipment of said user and object-occupancy information of a keyboard object corresponding to said object-resource information.

24. The method of claim 21, further comprising obtaining a user's input operation in said input hot-zone, performing a keyboard input operation corresponding to said input operation, and providing, to said user, a result of performing said keyboard input operation.

25. The method of claim 24, further comprising, according to said input operation, providing, to said user, input-prompt information corresponding to said input hot-zone, wherein said input-prompt information is selected from the group consisting of sound-effect information corresponding to said input hot-zone, and display information corresponding to said input hot-zone.

26. The method of claim 21, further comprising obtaining a user's keyboard-adjustment operation on said virtual input-keyboard, based at least in part on said keyboard-adjustment operation, updating one or more keyboard objects of said virtual input-keyboard and object-resource information corresponding to each keyboard object, based at least in part on said updated one or more keyboard objects and object-resource information corresponding to each keyboard object, generating said virtual input-keyboard, and providing said virtual input-keyboard to said user.

27. The method of claim 26, wherein said user's keyboard-adjustment operation is selected from the group consisting of adjusting location information of at least one of said one or more keyboard objects, adjusting shape information of at least one of said one or more keyboard objects, adjusting said input event(s) corresponding to said input hot-zone, and adjusting object-resource information corresponding to at least one of said one or more keyboard objects.

28. The method of claim 21, wherein obtaining one or more keyboard objects comprises obtaining said one or more keyboard objects based at least in part on said keyboard-description information, wherein at least one of said one or more keyboard objects comprises an input hot-zone for receiving user-input operation to trigger at least one corresponding input event, and obtaining said object-resource information corresponding to said keyboard object based at least in part on said keyboard object.

29. The method of claim 28, wherein obtaining said object-resource information corresponding to said keyboard object based at least in part on said keyboard object comprises obtaining object-resource-combination information, wherein said object-resource-combination information is generated by combining candidate object-resource information for generating said virtual input-keyboard, and extracting said object-resource information corresponding to said keyboard object from said object-resource-combination information based at least in part on said keyboard object.

30. The method of claim 28, wherein obtaining said object-resource information corresponding to said keyboard object based at least in part on said keyboard object comprises performing match query in a keyboard-object-resource repository, based at least in part on said keyboard object, to obtain said object-resource information corresponding to said keyboard object.

31. An apparatus for providing a virtual input-keyboard, said apparatus comprising a first obtaining-module, a second obtaining-module, a generating module, and a providing module, wherein said first obtaining-module is configured to obtain keyboard-description information of a virtual input-keyboard that is to be provided to a user, wherein said second obtaining-module is configured to, based at least in part on said keyboard-description information, obtain one or more keyboard objects corresponding to said virtual input-keyboard and object-resource information corresponding to each keyboard object, wherein at least one of said one or more keyboard objects comprises an input hot-zone for receiving user-input operations to trigger at least one corresponding input event, wherein said generating module is configured to generate said virtual input-keyboard based at least in part on said one or more keyboard objects and object-resource information corresponding to each keyboard object, and wherein said providing module is configured to provide said virtual input-keyboard to said user.

32. The apparatus of claim 31, wherein said generating module comprises an adaptation unit and a generating unit, wherein said adaptation unit is configured to, based at least in part on said predetermined object-adaptation-reference information, perform adaptation processing to said object-resource information to obtain said adapted object-resource information, and wherein said generating unit is configured to generate said virtual input-keyboard based at least in part on said one or more keyboard objects and said adapted object-resource information.

33. The apparatus of claim 32, wherein said predetermined object-adaptation-reference information is selected from the group consisting of a screen attribute of user equipment of said user, and object-occupancy information of a keyboard object corresponding to said object-resource information.

34. The apparatus of claim 31, further comprising a third obtaining-module, a performing module, and a displaying module, wherein said third obtaining-module is configured to obtain said user's input operation on said input hot-zone, wherein said performing module is configured to perform a keyboard input operation corresponding to said input hot-zone based at least in part on said input operation, and wherein said displaying module is configured to provide, to said user, a result of performing said keyboard input operation.

35. The apparatus of claim 34, wherein said apparatus is configured to, based at least in part on said input operation, provide input-prompt information corresponding to said input hot-zone to said user, wherein said input-prompt information is selected from the group consisting of sound-effect information corresponding to said input hot-zone, and display information corresponding to said input hot-zone.

36. The apparatus of claim 31, further comprising a fourth obtaining-module and an updating module, wherein said fourth obtaining-module is configured to obtain said user's keyboard-adjustment operation on said virtual input-keyboard, wherein said updating module is configured to, based at least in part on said keyboard-adjustment operation, update one or more keyboard objects of said virtual input-keyboard and object-resource information corresponding to each keyboard object, and wherein said apparatus performs operations performed by said generating module and said providing module based on said updated one or more keyboard objects and object-resource information corresponding to each keyboard object.

37. The apparatus of claim 36, wherein said keyboard-adjustment operation is selected from the group consisting of adjusting location information of at least one of said one or more keyboard objects, adjusting shape information of at least one of said one or more keyboard objects, adjusting said input event(s) corresponding to said input hot-zone, and adjusting object-resource information corresponding to at least one of said one or more keyboard objects.

38. The apparatus according to claim 31, wherein said second obtaining-module comprises a keyboard-object-obtaining unit and an object-resource information obtaining unit, wherein said keyboard-object-obtaining unit is configured to obtain said one or more keyboard objects based on said keyboard-description information, wherein at least one of said one or more keyboard objects comprises an input hot-zone for receiving user-input operation to trigger corresponding input event(s), and wherein said object-resource information obtaining unit is configured to obtain said object-resource information corresponding to said keyboard object based on said keyboard object.

39. The apparatus of claim 38, wherein said object-resource information obtaining unit is further configured to obtain object-resource-combination information, wherein said object-resource-combination information is generated by combining candidate object-resource information for generating said virtual input-keyboard, and to extract said object-resource information corresponding to said keyboard object from said object-resource-combination information based on said keyboard object.

40. The apparatus of claim 38, wherein said object-resource-information obtaining unit is further configured to perform match query in a keyboard-object-resource repository based on said keyboard object, and to obtain said object-resource information corresponding to said keyboard object.
